(19) United States
(12) Patent Application Publication
(10) Pub. No.: US 2025/0019145 A1
(43) Pub. Date: Jan. 16, 2025

(54) PHOTOVOLTAIC POWER GENERATION DEVICE

(71) Applicant: Hebei Qinhuai Data Co., Limited., Zhangjiakou City (CN)

(72) Inventor: Binghua ZHANG, Zhangjiakou City (CN)

(21) Appl. No.: 18/764,306

(22) Filed: Jul. 4, 2024

(30) Foreign Application Priority Data
Jul. 13, 2023 (CN) 202310861302.7

(51) Int. Cl. B65D 85/48; B65D 90/20

(52) U.S. Cl. CPC B65D 85/48; B65D 90/20

(57) ABSTRACT

The present disclosure discloses a photovoltaic power generation device, including two symmetrical bottom side beams. The bottom side beam is fixedly connected to a bottom secondary beam, and the two bottom side beams are fixedly connected to two symmetrical bottom end beams. The bottom end beam is provided with a corner fitting box through a bolt, and the corner fitting box is connected to the bottom side beam through a bolt. The bottom secondary beam is provided with two symmetrical bases through bolts, and the base is fixedly connected to a bearing seat. A flange plate is installed on the bearing seat through a rotating shaft, a highly rotating component is fixedly connected to the flange plate, and a photovoltaic panel is installed on the highly rotating component through a bolt.

### CROSSREFERENCE TO RELATED APPLICATION

This application claims priority to Chinese Patent Application No. 202310861302.7, titled “PHOTOVOLTAIC POWER GENERATION DEVICE” and filed to the China National Intellectual Property Administration on Jul. 13, 2023, the entire contents of which are incorporated herein by reference.

### TECHNICAL FIELD

The present disclosure relates to the field of photovoltaic power generation, and more particularly, to a photovoltaic power generation device.

### BACKGROUND

Photovoltaic power generation is a technology that utilizes photovoltaic effects of semiconductor interfaces to directly convert light energy into electrical energy. A photovoltaic power generation device essentially comprises three parts: a solar panel (a component), a controller, and an inverter, where main components comprise electronic components. After being connected in series and packaged for protection, solar cells may form large-area solar cell components, which, in combination with power controllers and other components, form the photovoltaic power generation device.

At present, there are two types of back support structures for photovoltaic panels used in domestic photovoltaic power plants in China. The first one is a fixed bracket, which has lower power generation efficiency. The second one is a support bracket strengthened on the back of the photovoltaic panel, which has higher power generation efficiency because both the support bracket and the photovoltaic panel can move with the sun. However, its on-site installation and debugging cycle is longer, and a large amount of installation work needs to be completed on a construction site, making it difficult to be flexibly deployed. Therefore, it is required to provide a structure that can be quickly installed on the site, and it is required to ensure safety of the photovoltaic equipment during transportation to the installation site.

### SUMMARY

The present disclosure provides a photovoltaic power generation device to solve a problem of potential failure of rapid delivery caused by lower efficiency in on-site installation of the photovoltaic power generation device.

According to an embodiment of the present disclosure, there is provided a photovoltaic power generation device, which includes two symmetrical bottom side beams, The bottom side beam is fixedly connected to a bottom secondary beam, and the two bottom side beams are fixedly connected to two symmetrical bottom end beams. The bottom end beam is provided with a corner fitting box through a bolt, and the corner fitting box is connected to the bottom side beam through a bolt. The bottom secondary beam is provided with two symmetrical bases through bolts, and the base is fixedly connected to a bearing seat. A flange plate is installed on the bearing seat through a rotating shaft, a highly rotating component is fixedly connected to the flange plate, and a photovoltaic panel is installed on the highly rotating component through a bolt. A folding frame is separately installed on the bottom side beam and the bottom end beam through bolts.

In the photovoltaic power generation device of the present disclosure, there are a plurality of the bottom secondary beams, and the plurality of bottom secondary beams are uniformly distributed on the two bottom side beams. By designing the bottom secondary beams, the two bottom side beams may be combined, and the base may be supported and installed.

In the photovoltaic power generation device of the present disclosure, number of the corner fitting boxes is four, and the four corner fitting boxes are evenly distributed on the two bottom end beams. By designing the corner fitting boxes, an overall structure may be installed and used by means of the corner fitting boxes.

In the photovoltaic power generation device of the present disclosure, the flange plate is provided with a plurality of mounting holes annularly distributed on the flange plate. By designing the mounting holes, the flange plate may be installed by fitting the bolts with the mounting holes.

In the photovoltaic power generation device of the present disclosure, a shaft hole is provided on the flange plate, and the rotating shaft is arranged inside the shaft hole. By designing the shaft hole, rotation of the flange plate can be achieved.

In the photovoltaic power generation device of the present disclosure, there are a plurality of the photovoltaic panels, and the plurality of photovoltaic panels are uniformly distributed on the two bases. By designing the plurality of photovoltaic panels, photovoltaic power generation may be carried out.

The technical solutions provided by the embodiments of the present disclosure may include following beneficial effects.
1. The present disclosure adopts a prefabricated photovoltaic power generation structure, which is installed and debugged in a workshop and is safely transported to a site for quick installation, thereby avoiding failure of rapid delivery for power generation caused by a large amount of work accumulation on the site, achieving installation and debugging in the workshop, and completing rapid on-site delivery.
2. By designing the folding frame, it is convenient to lay a dustproof and rainproof cloth to cover components during transportation, thereby ensuring the safety of the photovoltaic equipment during the transportation. When the photovoltaic components are transported to the site, the folding frame is disassembled, and then the photovoltaic components are installed as an overall structure for use through the corner fitting boxes. In this way, convenience in installation and use of the photovoltaic power generation device is improved, making it convenient and efficient for operation.

### BRIEF DESCRIPTION OF THE DRAWINGS

To describe the technical solutions of the embodiments of the present disclosure more clearly, the accompanying drawings required for describing the embodiments will be briefly introduced below. Apparently, the accompanying drawings in the following description are merely some embodiments of the present disclosure. To those of ordinary skills in the art, other accompanying drawings may also be derived from these accompanying drawings without creative efforts.

FIG. 1 is a three-dimensional view of an overall structure according to the present disclosure;

FIG. 2 is a side view of the structure in FIG. 1 according to the present disclosure;

FIG. 3 is a top view of a bottom side beam in FIG. 1 according to the present disclosure; and

FIG. 4 is a schematic diagram of a highly rotating component of FIG. 2 according to the present disclosure.

Reference numerals in the accompanying drawings:

bottom side beam 1; bottom secondary beam 2; bottom end beam 3; corner fitting box 4; bearing seat 5; flange plate 6; highly rotating component 7; photovoltaic panel 8; folding frame 9; mounting hole 10; shaft hole 11; and base 12.

### DETAILED DESCRIPTION

Technical solutions in the embodiments of the present disclosure will be described clearly and completely below, in conjunction with the accompanying drawings in the embodiments of the present disclosure. Apparently, the described embodiments are some but not all of the embodiments of the present disclosure. All other embodiments obtained by a person of ordinary skill in the art based on the embodiments of the present disclosure without creative efforts shall fall within the protection scope of the present disclosure.

It should also be understood that the terms used in this specification of the present disclosure are only for the purpose of describing particular embodiments and are not intended to limit the present disclosure. As used in the specification and the appended claims of the present disclosure, the singular forms of “a”, “an” and “the” may be intended to include the plural forms, unless the context clearly indicates otherwise.

It should also be further understood that the term “and/or” used in the specification and the appended claims of the present disclosure refers to any combination of one or more of the relevantly listed items and all possible combinations, and includes these combinations.

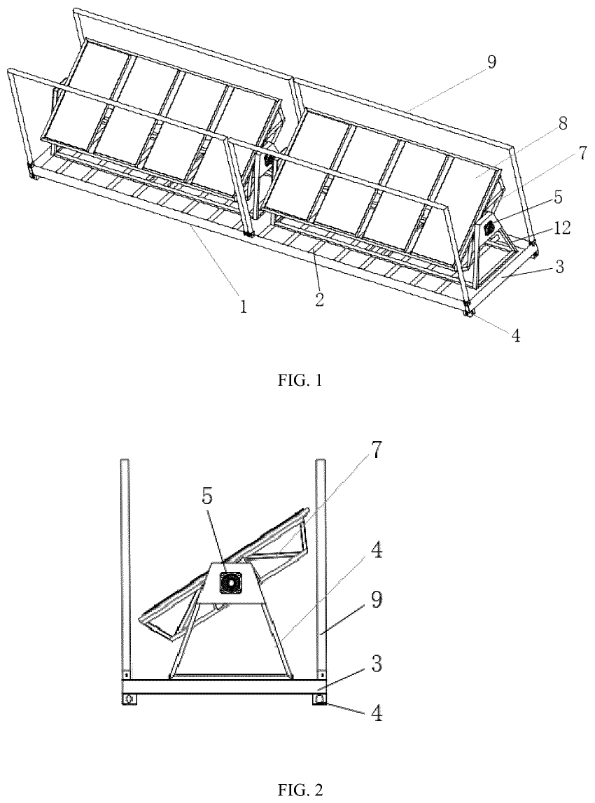

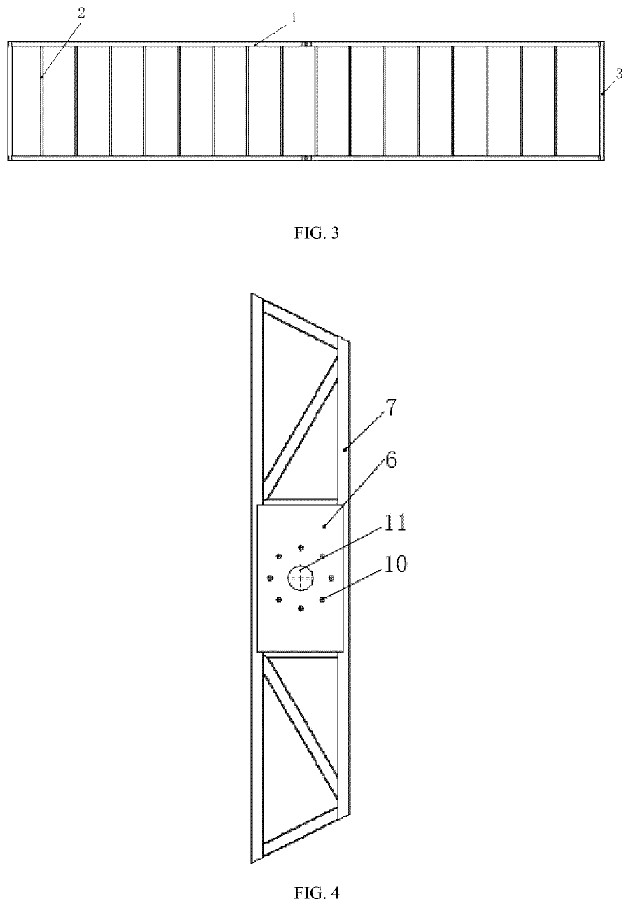

Referring to FIG. 1, FIG. 2, and FIG. 3, a photovoltaic power generation device includes two symmetrical bottom side beams 1. The two bottom side beams 1 are fixedly connected to a plurality of bottom secondary beams 2 evenly distributed on the two bottom side beams 1. By designing the bottom secondary beams 2, the two bottom side beams 1 may be combined, and two bases 12 may be supported and installed. The two bottom side beams 1 are fixedly connected to two symmetrical bottom end beams 3. Four corner fitting boxes 4 are installed on the two bottom end beams 3 through bolts, and are connected to the two bottom side beams 1 through bolts. The four corner fitting boxes 4 are evenly distributed on the two bottom end beams 3. By designing the corner fitting boxes 4, the photovoltaic power generation device may be installed as an overall structure for use by means of the four corner fitting boxes 4. Two symmetrical bases 12 are installed on the bottom secondary beams 2 through bolts.

Referring to FIG. 1, FIG. 2, and FIG. 4, the base 12 is fixedly connected to a bearing seat 5, a flange plate 6 is installed on the bearing seat 5 through a rotating shaft, a highly rotating component 7 is fixedly connected to the flange plate 6, and the flange plate 6 is provided with a plurality of mounting holes 10 annularly distributed on the flange plate 6. By designing the mounting holes 10, the flange plate 6 may be installed by fitting the bolts with the mounting holes 10. A shaft hole 11 is provided on the flange plate 6, and the rotating shaft is arranged inside the shaft hole 11. By designing the shaft hole 11, rotation of the flange plate 6 can be achieved. A plurality of photovoltaic panels 8 are installed on the highly rotating component 7 through bolts, and the plurality of photovoltaic panels 8 are uniformly distributed on the two bases 12. By designing the plurality of photovoltaic panels 8, photovoltaic power generation may be carried out. A folding frame 9 is separately installed on the bottom side beams 1 and the bottom end beams 3 through bolts.

Specific implementation processes of the present disclosure are as follows. When in use, by adopting a prefabricated photovoltaic power generation structure, the photovoltaic power generation device is installed and debugged in a workshop and is safely transported to a site for quick installation, thereby avoiding failure of rapid delivery for power generation caused by a large amount of work accumulation on the site, achieving installation and debugging in the workshop, and completing rapid on-site delivery. When it is required to transport the photovoltaic power generation device, the folding frame 9 is first covered with a dustproof and rainproof cloth to protect internal photovoltaic components and ensure safety of the photovoltaic equipment during transportation. After the transportation is completed, the photovoltaic power generation device is moved to a location where it is to be installed, the dustproof and rainproof cloth is removed, and then the folding frame 9 is disassembled. Next, the photovoltaic components can be installed as an overall structure for use through the corner fitting boxes 4. In this way, convenience in installation and use of the photovoltaic power generation device is improved, making it convenient and efficient for operation.

The preceding descriptions are merely specific embodiments of the present disclosure, but are not intended to limit the protection scope of the present disclosure. Any equivalent modifications or replacements easily conceivable to a person of skilled in the art within the technical scope disclosed in the present disclosure shall fall within the scope of protection of the present disclosure. Therefore, the protection scope of the present disclosure shall be subject to that of the claims.

What is claimed is:

1. A photovoltaic power generation device comprising two symmetrical bottom side beams, wherein the bottom side beam is fixedly connected to a bottom secondary beam, the two bottom side beams are fixedly connected to two symmetrical bottom end beams, the bottom end beam is provided with a corner fitting box through a bolt, the corner fitting box is connected to the bottom side beam through a bolt, the bottom secondary beam is provided with two symmetrical bases through bolts, the base is fixedly connected to a bearing seat, a flange plate is installed on the bearing seat through a rotating shaft, a highly rotating component is fixedly connected to the flange plate, a photovoltaic panel is installed on the highly rotating component through a bolt, and a folding frame is separately installed on the bottom side beam and the bottom end beam through bolts.

2. The photovoltaic power generation device according to claim 1, wherein there are a plurality of the bottom secondary beams, and the plurality of bottom secondary beams are uniformly distributed on the two bottom side beams.

3. The photovoltaic power generation device according to claim 1, wherein number of the corner fitting boxes is four, and the four corner fitting boxes are evenly distributed on the two bottom end beams.

4. The photovoltaic power generation device according to claim 1, wherein the flange plate is provided with a plurality of mounting holes annularly distributed on the flange plate.

5. The photovoltaic power generation device according to claim 1, wherein a shaft hole is provided on the flange plate, and the rotating shaft is arranged inside the shaft hole.

6. The photovoltaic power generation device according to claim 1, wherein there are a plurality of the photovoltaic panels, and the plurality of photovoltaic panels are uniformly distributed on the two bases.
